(19) United States
(12) Patent Application Publication
(10) Pub. No.: US 2024/0192646 A1
(43) Pub. Date: Jun. 13, 2024

(54) METHODS FOR ACCELERATED DEVELOPMENT PLANNING OPTIMIZATION USING MACHINE LEARNING FOR UNCONVENTIONAL OIL AND GAS RESOURCES

(71) Applicant: ExxonMobil Technology and Engineering Company, Spring, TX (US)

(72) Inventors: Sriram DORAISWAMY, The Woodlands, TX (US); Jai MANIK, Karnataka (IN); Fahim FOROUZANFAR, Spring, TX (US); Kyle GUICE, Houston, TX (US); Xiaohui WU, Sugar Land, TX (US)

(21) Appl. No.: 18/555,098

(22) PCT Filed: Feb. 3, 2022
(86) PCT No.: PCT/US2022/070492

§ 371 Date: Oct. 12, 2023

Related U.S. Application Data
(60) Provisional application No. 63/179,594, filed on Apr. 26, 2021.
(60) Provisional application No. 63/208,132, filed on Jun. 8, 2021.

(51) Int. Cl. G05B 13/02

(52) U.S. Cl. CPC G05B 13/0265

(57) ABSTRACT

Methods for analyzing subsurface process data in order to perform one or more subsurface operations in a subsurface are provided. Generating subsurface models is typically a long and laborious process in which subsurface process data is analyzed in order to generate the subsurface models. In contrast, work in generating the subsurface models may be front-loaded by first using a physics simulator in order to generate a training set of subsurface forward models, and then performing machine learning using the training set to generate one or more proxy models, such as a forward proxy model and an inverse proxy model. The machine learning may be constrained using physics-based rules to better converge on the proxy models. In this way, the already-trained inverse proxy model may input the subsurface process data in order to generate potential inverse models, which may then be used to perform subsurface operations in the subsurface.

### CROSS-REFERENCE TO RELATED APPLICATIONS

This application is the U.S. National Stage Application of the International Application No. PCT/US2022/070492, entitled “METHODS FOR ACCELERATED DEVELOPMENT PLANNING OPTIMIZATION USING MACHINE LEARNING FOR UNCONVENTIONAL OIL AND GAS RESOURCES,” filed on Feb. 3, 2022, the disclosure of which is hereby incorporated by reference in its entirety, which claims priority to and the benefit of U.S. Provisional Application No. 63/179,594, filed on Apr. 26, 2021, and U.S. Provisional Application No. 63/208,132, filed on Jun. 8, 2021, the entire contents of which are incorporated herein by reference.

### FIELD OF THE INVENTION

The present application relates generally to the field of hydrocarbon production. Specifically, the disclosure relates to a methodology for generating subsurface models using machine learning in order to accelerate development planning optimization in extracting unconventional oil and gas resources.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Unconventional hydrocarbon extraction may involve a stimulation process in combination with conventional drilling. Hydrocarbons that may necessitate unconventional hydrocarbon extraction include, for example, shale oil, tight oil, tight gas, coalbed methane, coal mine methane, oil shale, oil sands, and shale gas. One example stimulation process comprises fracking (also known as hydraulic fracturing), which involves injecting fluid at high pressure into underground rock in order to open fissures, thereby allowing trapped gas or crude oil to be extracted. In this regard, unconventional hydrocarbon extraction is typically more difficult than conventional drilling.

Well performance for unconventional hydrocarbon extraction is influenced by a variety of factors (e.g., geology, hydraulic fracture geometry, etc.) that may not be easily measured or accurately estimated even with state-of-the-art instrumentation such as downhole gauges, well interference tests, microseismic, DTS/DAS, etc. Therefore, the impact of completions and geologic factors on the performance of the wells remain uncertain given the available data. The result of these uncertainties is that there is a wide distribution of possible subsurface representations that all are equally likely for a given observed response (e.g., production data or diagnostics data).

Development planning in unconventional hydrocarbon extraction essentially involves two key steps: (1) matching observed response by adjusting reservoir/completion parameters to create a set of likely subsurface scenarios; and (2) optimizing over the matched scenarios (or conditioned scenarios) for different operation strategies (e.g., well spacing (e.g., distance between wells in the lateral or horizontal plane), well landing (e.g., depth to place the horizontals), drawdown (e.g., how much force to draw the oil from the rock), etc.).

Both (1) and (2) involve creating subsurface models (e.g., reservoir models; hydraulic fracturing models) with different inputs to predict the production response. In this regard, unconventional hydrocarbon extraction involves accurately modeling the subsurface geologic structures and detect fluid presence in those structures. For example, a geologic model, which may comprise a computer-based representation, such as a two-dimensional (“2D”) representation or a three-dimensional (“3D”) representation, of a region beneath the earth's surface. Such models may be used to model a petroleum reservoir, a depositional basin, or other regions which may have valuable mineral resources. Once the model is constructed, it may be used to assist in the unconventional hydrocarbon extraction.

### SUMMARY OF THE INVENTION

In one or some embodiments, a computer-implemented method for analyzing subsurface process data in order to perform one or more subsurface operations in a subsurface is disclosed. The method includes: accessing the subsurface process data indicative of at least one subsurface process, the subsurface process data being periodically generated; analyzing, using the subsurface process data, previously generated subsurface models in order to select a subset of previously generated subsurface models; iteratively, responsive to receiving additional subsurface process data, analyzing, using the additional subsurface process data, reducing the previously generated subsurface models in the subset; and using one or more of the previously generated subsurface models in the subset in order to perform the one or more subsurface operations in the subsurface.

In one or some embodiments, a computer-implemented method for generating an inverse proxy model in order to perform one or more subsurface operations in a subsurface is disclosed. The method includes: generating, using a physics simulator solving differential equations, a training set of forward models; generating, via machine learning using the training set of forward models, a forward proxy model; generating, via the machine learning using the training set of forward models, an inverse proxy model such that the inverse proxy model is consistent with the forward proxy model; receiving subsurface process data; using the subsurface process data as input to the inverse proxy model in order to generate outputs comprising geological parameters and parameters related to completions that are indicative of potential inverse models; and using one or more of the potential inverse models to perform the one or more subsurface operations in the subsurface.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a flow chart for iteratively selecting previously generated subsurface models based on subsurface process data.

FIG. 2 is a flow chart for generating subsurface models, such as forward subsurface models, using two methodologies.

FIG. 3 is a flow chart for using a physics simulator and machine learning to generate a forward proxy model, for using the forward proxy model to generate an inverse proxy model, and for using the inverse proxy model to generate a set of inverse subsurface models.

FIG. 4 is a flow chart for iteratively selecting inverse subsurface models based on subsurface process data and determining whether to use the selected inverse subsurface models.

FIG. 5 is a block diagram for generating and using the subsurface models.

FIGS. 6A-D are block diagrams for iteratively reducing the inverse subsurface models based on the production data received.

FIG. 7 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or interpretation quantities, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (e.g., acoustic) data sets in conjunction with other geophysical data, including, for example, gravity plus seismic; gravity plus electromagnetic plus seismic data, etc. For example, joint-inversion utilizes multiple geophysical data types.

The term “geophysical data” as used herein broadly includes seismic data, as well as other data obtained from non-seismic geophysical methods such as electrical resistivity. In this regard, examples of geophysical data include, but are not limited to, seismic data, gravity surveys, magnetic data, electromagnetic data, well logs, image logs, radar data, or temperature data.

The term “geological features” (interchangeably termed geo-features) as used herein broadly includes attributes associated with a subsurface, such as any one, any combination, or all of: subsurface geological structures (e.g., channels, volcanos, salt bodies, geological bodies, geological layers, etc.); boundaries between subsurface geological structures (e.g., a boundary between geological layers or formations, etc.); or structure details about a subsurface formation (e.g., subsurface horizons, subsurface faults, mineral deposits, bright spots, salt welds, distributions or proportions of geological features (e.g., lithotype proportions, facies relationships, distribution of petrophysical properties within a defined depositional facies), etc.). In this regard, geological features may include one or more subsurface features, such as subsurface fluid features, that may be hydrocarbon indicators (e.g., Direct Hydrocarbon Indicator (DHI)). Examples of geological features include, without limitation salt, fault, channel, environment of deposition (EoD), facies, carbonate, rock types (e.g., sand and shale), horizon, stratigraphy, or geological time.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) is represented by picture elements (pixels). Such numerical representations may be shape-based or functional forms in addition to, or in lieu of, cell-based numerical representations.

The term “subsurface model” as used herein refer to a numerical, spatial representation of a specified region or properties in the subsurface.

The term “geologic model” as used herein refer to a subsurface model that is aligned with specified geological feature such as faults and specified horizons.

The term “reservoir model” as used herein refer to a geologic model where a plurality of locations have assigned properties including any one, any combination, or all of rock type, EoD, subtypes of EoD (sub-EoD), porosity, clay volume, permeability, fluid saturations, etc.

For the purpose of the present disclosure, subsurface model, geologic model, and reservoir model are used interchangeably unless denoted otherwise.

Stratigraphic model is a spatial representation of the sequences of sediment, formations and rocks (rock types) in the subsurface. Stratigraphic model may also describe the depositional time or age of formations.

Structural model or framework results from structural analysis of reservoir or geobody based on the interpretation of 2D or 3D seismic images. For examples, the reservoir framework comprises horizons, faults and surfaces inferred from seismic at a reservoir section.

As used herein, “hydrocarbon management” or “managing hydrocarbons” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, subsurface models are used in order to assist with hydrocarbon management. In particular, subsurface models may be used to assist in unconventional hydrocarbon extraction to perform the conventional methodology step (1) (matching production history step) and step (2) (optimizing step). Ultimately, the goal is to select parameters that are controllable in order to optimize the hydrocarbon production process based on predefined criteria (e.g., greatest amount of oil extraction, most cost effective oil extraction (balancing the costs associated with performing fracking (including costs associated with generating the fractures and costs of maintaining the fractures) against the benefits of the extracted oil), etc.). The subsurface models may be dependent on an observed response (interchangeably termed subsurface process data). Various types of subsurface process data are contemplated, including one or both of: production data (e.g., Yₒᵢₗ, Y_{gas}, and Y_{water}, discussed below); or diagnostics data (e.g., data from monitoring wells). As such, any discussion herein regarding production data may be equally applied to other types of subsurface process data, including diagnostics data.

Specifically, subsurface forward models, used to optimize the hydrocarbon production process, include one or more inputs and one or more outputs. Merely by way of example, inputs to the subsurface forward models include any one, any combination, or all of: geological parameters (X_{G}) (e.g., porosity, permeability, etc.); parameters related to completions (X_{C}) (e.g., fracture geometry, number of fractures, etc.); and parameters related to operations (X_{P}) (e.g., well spacing, the number of neighboring wells, etc.). In practice, X_{P} is entirely controllable (e.g., the operator may select the spacing between wells, the number of neighboring wells, or the like), X_{C} is partially controllable (e.g., X_{C} is influenced both by parameters within operator control (e.g., X_{P}) and outside of operator control (e.g., X_{G}), and X_{G} is not controllable at all (e.g., X_{G} relates to subsurface parameters). Conversely, an example output for the subsurface forward model includes production data, which may include any one, any combination, or all of: production data directed to oil (Yₒᵢₗ); production data directed to gas (Y_{gas}); or production data directed to water (Y_{water}). The production data may be packaged in one of several forms, including production response or time series (e.g., oil rate, gas rate). Another example output for the subsurface forward model includes diagnostics data. Other hydrocarbon production process inputs and outputs are contemplated. In this regard, the subsurface models may be analyzed in order to optimize the selection of the various inputs and/or outputs.

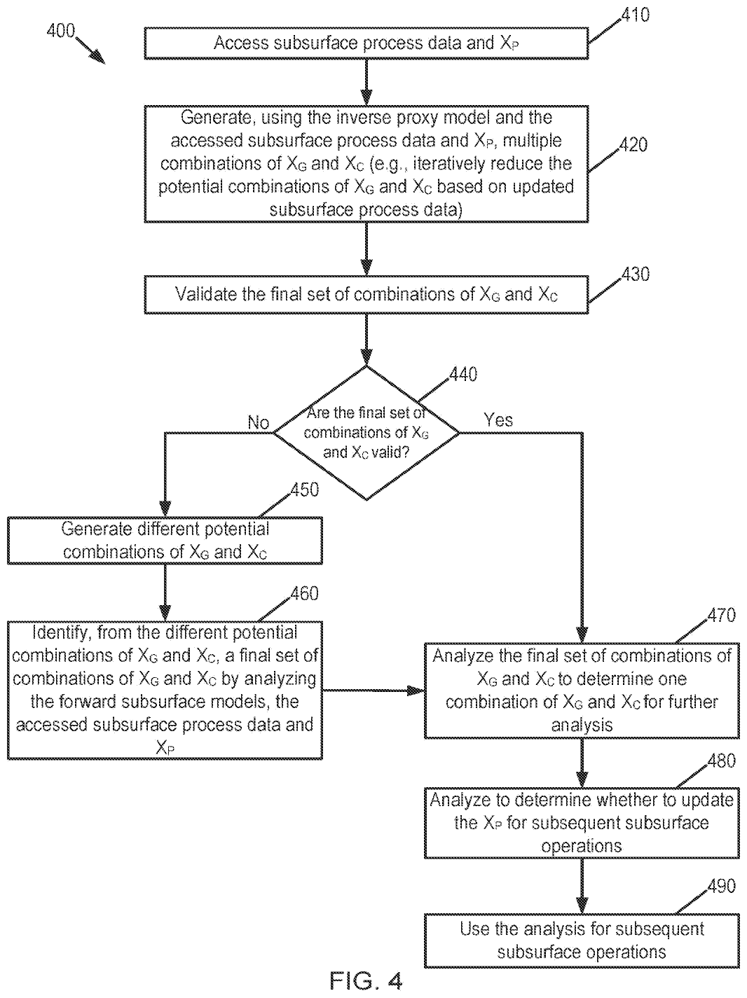

For example, the physics simulator, such as the reservoir simulator or hydraulic fracturing simulator, may receive input and generate output. The input to a respective simulator may be generated in a single step or in multiple steps. For example, FIG. 4, discussed below, illustrates the input to the physics simulator as a single-step. Alternatively, multiple steps may be performed prior to introduction to the physics simulator. In one way, the multiple steps may comprise modifying the data prior to introduction into the simulator, such as by conditioning, performing quality control, or the like. In another way, the multiple steps may include using a simulator in order to generate an output, which in turn is input to another simulator. Merely by way of example, inputs, such as X_{G} (e.g., geological parameters relevant to hydraulic fracturing such as stress profiles), X_{C} (e.g., completion parameters relevant to hydraulic fracturing such as locations of the holes in the wellbore; distance of the holes from the surface) and X_{P} (e.g., operation parameters relevant to hydraulic fracturing such as at what rate or pressure water is pumped) may be input to a hydraulic fracturing simulator, which in response thereto may generate output(s) (such as fracturing geometries, which are akin to what may be sensed by monitoring wells as part of diagnostics measurements). In turn, the output(s) from the hydraulic fracturing simulator are input to a reservoir simulator, which may then be used to generate production data (e.g., Yₒᵢₗ, Y_{gas}, and Y_{water}). Thus, the physics simulator in one embodiment may comprise a single simulator, such as a hydraulic fracturing simulator or a reservoir simulator. Alternatively, the physics simulator may comprise multiple simulators, such as simulators daisy-chained together with an output generated by a first simulator input (either directly or after an intermediate step) into the second simulator.

Similarly, subsurface inverse models may likewise include various inputs correlated to various outputs. Merely by way of example, inputs to the subsurface inverse models may include any aspect that is able to be sensed and/or controllable. For example, the inputs to the subsurface inverse models may include one or both of: parameters related to operations (X_{P}) (which are controllable); and the production data that may be sensed (e.g., production data directed to oil (Yₒᵢₗ); production data directed to gas (Y_{gas}); or production data directed to water (Y_{water})). Further, outputs to the subsurface inverse models may include one or more aspects regarding the subsurface and/or one or more aspects regarding performance of the stimulation of the subsurface. For example, the outputs to the subsurface inverse models may include one or both of: geological parameters (X_{G}) (which describes one or more aspects of the subsurface); parameters related to completions (X_{C}) (which describes the results of fracking in the subsurface).

However, in the optimization, prior methodologies generated subsurface models (whether subsurface forward models or subsurface inverse models) responsive to receiving subsurface process data (e.g., production data and/or fracking data). In this regard, the prior methodologies were severely limited by long cycle times, such as several months, in performing both steps (1) and (2).

Thus, in one or some embodiments, the methodology generates subsurface models first (e.g., prior to receipt of the subsurface process data). The generation of the subsurface models may be manifested in one or more ways. In one way, the subsurface models may be generated individually by correlating respective inputs to respective outputs. Alternatively, or in addition, the subsurface models may be manifested in a proxy model (such as one or both of a forward proxy model or an inverse proxy model). In one or some embodiments, the proxy model are components that behave like the subsurface models from the perspective of a view, and access data from subsurface models used for training on behalf of that view, as discussed further below.

As discussed in more detail below, via machine learning (such as machine learning constrained by physics-based rules) using a set of subsurface models (such as using an initial set of forward subsurface models generated by a physics simulator using an initial set of inputs), the proxy model may be generated. In turn, the proxy model may be used to generate additional models (e.g., the forward proxy model generating subsurface forward models; the inverse proxy model generating subsurface inverse models). In this way, the processing is front-loaded (such as by generating the initial set of forward models (that act as a training set of subsurface models) and performing the constrained machine learning using the initial set of forward models to generate one or both of the forward proxy model or the inverse proxy model), and is performed prior to receiving the subsurface process data.

The subsurface models generated may comprise one or both of the subsurface forward models (e.g., the forward proxy model manifesting the subsurface forward models) or the subsurface inverse models (e.g., the inverse proxy model manifesting the subsurface inverse models). The subsurface models generated may be generally directed to any region (e.g., to any subsurface), or may be specific to a region of the planet (e.g., Eagle Ford, the Permian basin, the Alaska North Slope), to a specific location (e.g., latitude and longitude), to a specific depth (e.g., a depth of 10K feet for one set of subsurface models; a depth of 12K feet for one set of subsurface models; etc.), to a specific location and depth, or the like. After which, the methodology iteratively selects a subset of the previously generated subsurface models based on the subsurface process data.

For example, after generating the subsurface models, the operator may select certain operator controlled parameters (e.g., parameters related to operations (X_{P})) and may receive production data periodically (such as in predetermined periodic intervals, such as daily, weekly, etc.). At time t=0, the first set of subsurface process data may be received. Responsive to receiving the first set of subsurface process data, using the subsurface process data at time t=0 and the operator-controlled parameters, a subset of the previously generated subsurface models may be selected as potential candidates of subsurface models that match (within preset tolerances) of the subsurface process data and operator-controlled parameters. For example, the subsurface process data and operator-controlled parameters may be input to the inverse proxy model (previously generated via machine learning to receive different combinations of subsurface process data and operator-controlled parameters (X_{P}) and to output geological parameters (X_{C}) and parameters related to completions (X_{C})). At one, some, or each time of receipt of additional production data (e.g., at time t=1, 2, 3, etc.), the methodology may further reduce the subset of previously generated subsurface models that comports (within defined tolerances) with some or all of the subsurface process data received and the operator-controlled parameters. For example, at time t=1, the methodology may use the subsurface process data for both t=0 and t=1 in order to select the subset of previously generated subsurface models that comports (within defined tolerances) of the subsurface process data for t=1 (or for both t=0 and t=1) and the operator-controlled parameters. In one particular example, the inverse proxy model may receive as input the subsurface process data for both t=0 and t=1 and operator-controlled parameters (X_{P}), and in turn output geological parameters (X_{G}) and parameters related to completions (X_{C}). Thus, the inverse proxy model may be iteratively used some or all of the instances where additional subsurface process data is received.

For example, in one or some embodiments, responsive to a first iteration, the methodology may select an initial subset of the previously generated subsurface models (e.g., the inverse proxy model generates 100 subsurface models as potential candidates), and in a second iteration, the methodology may identify fewer subsurface models as potential candidates. With each successive iteration, the methodology may further narrow the set of potential candidates. In this way, the methodology may iteratively identify the set of potential candidates until a predefined event (e.g., the subsurface process data is no longer available or until successive iterations fail to further reduce the number of potential subsurface models (e.g., after three iterations where the number of potential subsurface models remains the same, the methodology ceases to iterate)).

Alternatively, the methodology does not further reduce the subset of previously generated subsurface models responsive to each receipt of additional production data. In one or some embodiments, the methodology may wait for a predetermined amount of production data (e.g., data from at time t=0, 1, 2, 3) until the methodology generates the set of potential candidates based on the subsurface process data received and the operator-controlled parameters. For example, the methodology may iterate every predetermined number of time periods of receipt of subsurface process data (e.g., every four time periods of subsurface process data, with iteration #1 performed using data from at time t=0, 1, 2, 3, iteration #2 performed using data from at time t=4, 5, 6, 7, etc.). As another example, the methodology may perform the selection only once after sufficient subsurface process data has been received.

The proxy models (such as forward proxy model and/or the inverse proxy model) may be generated in one of several ways. In one way, subsurface forward models may be generated in a multi-stage process, and in turn be used to generate the proxy models. For example, in one or some embodiments, the multi-stage process may comprise at least the following two stages: (1) generating a first set of subsurface models using a first methodology; and (2) generating a second set of subsurface models (manifested in the proxy model) using a second methodology. In particular, the first methodology may comprise using a physics simulator that manifests partial differential equations and model physics principles or rules coded therein in order to generate a first set (or an initial set) of subsurface forward models corresponding to a first set (or an initial set) of inputs. The second methodology may comprise using machine learning, which may be constrained with the physics principles or rules coded therein, and the first set of subsurface forward models as input in order to generate a proxy model (such as the forward proxy model and/or the inverse proxy model). In turn, the proxy model may be used to generate a second set of subsurface forward models using a second set of inputs, which may be different from the first set of inputs used to generate the first set of subsurface forward models. In this regard, the proxy model, once generated, may act as a quicker way to identify the potential subsurface models responsive to receipt of subsurface process data. For example, in the context of subsurface forward models, the forward proxy model, once generated, may act as a replacement for the physics simulator in generating subsurface forward models.

In practice, the physics simulator, used for generating the first set of subsurface forward models, may be more computationally expensive in generating a respective subsurface forward model than the forward proxy model. For example, the physics simulator may take on the order of minutes to generate a single subsurface forward model in contrast to the forward proxy model, which may take on the order of seconds. In this regard, the forward proxy model may be at least an order of magnitude faster (or at least two orders of magnitude faster) than the physics simulator in generating subsurface forward models. As discussed below, the number in the first set of subsurface forward models generated by the physics simulator (and thereafter used as input for the machine learning) is at least an order of magnitude less than the number in the second set of subsurface forward models generated by the forward proxy model. Merely by way of example, the physics simulator, being more computationally expensive, may generate on the order of 100 thousand subsurface forward models (e.g., no more than 100 thousand subsurface models; no more than 200 thou sand subsurface models; no more than 300 thousand subsurface models; etc.), which may be sufficient to train the machine learning to generate the proxy model (such as one or both of the forward proxy model or the inverse proxy model). In turn, the forward proxy model, being less computationally expensive, may generate on the order of over a million subsurface forward models (e.g., at least one million forward models; at least two million forward models; at least three million forward models; at least four million forward models: at least five million forward models; etc.). As such, the physics simulator may generate a sufficient number of forward models at a higher computational cost in order to train the machine learning to generate the forward proxy model, which may then generate forward models at least an order of magnitude greater in number at a lower (per forward model generated) computational cost.

Further, as discussed above, there are various inputs that may be considered. With regard to production data, the inputs include geological parameters (X_{G}), parameters related to completions (X_{C}), and parameters related to operations (X_{P}). In total, the number of parameters may be at least 10, at least 20, at least 30, at least 40, at least 50, at least 60, at least 70, at least 80, at least 90, or at least 100. Further, one, some, or each of the parameters may have associated with them ranges of values or multiple discrete values. As one example, geological parameters (X_{G}) may relate to porosity, permeability, or the like, and may have associated ranges. The ranges may be selected in one of several ways, such as based on field samples, which may guide acceptable ranges for the geological parameters. In this way, the ranges for the geological parameters may be dependent on the specific basin in which the hydrocarbons are being extracted. As another example, parameters related to operations (X_{P}) may include well spacing, which may comprise a range of values (e.g., spacing in a range from X-Y feet), and may include number of neighboring wells, which may comprise a finite set of discrete values (e.g., 2 neighboring wells, 3 neighboring wells, etc.).

In one or some embodiments, the input values for the forward models generated by one or both of the physics simulator or the forward proxy model may be representative of different combinations of inputs to the forward models. Merely by way of example, at least 60 parameters may be included as inputs for geological parameters (X_{G}), parameters related to completions (X_{C}), and parameters related to operations (X_{P}). The practical reality is that generating forward models for all combinations of the inputs is not feasible. Instead, representative combinations of inputs may be selected. For example, for each of the 60 parameters, representative values may be selected (by the operator and/or by the physics simulator). In particular, with regard to well spacing, three values may be selected (for well spacing with a range X-Y feet, values may include well spacing=X feet, well spacing=(X+Y)/2 feet, and well spacing=Y feet, thereby evenly spacing across the designated range). Likewise, values may be selected for each of the other 59 parameters.

As discussed above, in one or some embodiments, the physics simulator generates a sufficient number of models to train the machine learning to generate the proxy model(s). As one example, the physics simulator may generate 100 thousand models, so that 100 thousand different combinations of inputs are available. The selection of the 100 thousand different combinations of inputs may be such that they represent a sufficient cross section for the machine learning to later accomplish its task of generating reliable and stable proxy model(s). In turn, the proxy model(s) may generate at least a million models, with 1 million different combinations of inputs. In one or some embodiments, the different combinations of inputs for the proxy model may be generated based on one or more criteria including: (1) interpolating between the values as inputs for the physics simulator (e.g., comprise a range of values (e.g., for the physics simulator, inputs for well spacing at X feet, (X+Y)/2 feet, and Y feet; for the forward proxy simulator, inputs for well spacing at X+0.1Y feet, X+0.2Y feet, etc.).

In this way, the methodology may use the physics simulator to build a massive dataset of subsurface process responses for a wide variety of subsurface realizations and completions (e.g., at least 100 thousand models), and then use machine learning and data analytic methods on the dataset to support development planning decision making process (e.g., utilizing machine learning and deep learning methods to generate the forward proxy model and/or the inverse proxy model for estimating probable scenarios and concepts as well as statistical analysis on the scenarios results to make robust optimal development plan). As discussed above, the number of parameters may be dozens, such as at least 60. In this regard, the high dimensionality of the problem makes it intractable to exclusively use a physics-based simulator to sweep all the dimensions. Hence, the physics simulator may be used to generate a sufficient number of models, which in turn may be used to generate a machine-learned proxy model(s) to then assist with generating additional models.

In particular, the physics simulator (such as a reservoir simulator or a hydraulic fracturing simulator) may use an initial dataset comprising a variety of cases representative of different scenarios such as different reservoirs, completions, and operation parameters (e.g., 60+ dimensions) to be created in order to generate outputs. As one example, the reservoir simulator may generate as output the production data (e.g., the production response of Yₒᵢₗ, Y_{gas}, and Y_{water}). As another example, the hydraulic fracturing simulator may generate a different set of outputs, such as diagnostics data (e.g., pressure data track how the pressure changes or bleeds responsive to pumping water at different pressures). In this way, the physics simulator may simulate the observed response indicative of one or more aspects of the subsurface. After the physics simulator generates the subsurface forward models, machine learning may be performed using the subsurface forward models in order to generate the proxy model(s) configured to generate subsurface models (e.g., capable of predicting the subsurface response for a set of input parameters). In this regard, the proxy models, in and of themselves, do not create new models, instead relying on inputs to the proxy models to generate new models while referencing the subsurface forward models generated by the physics simulator.

More specifically, the inverse proxy model may be generated using the set of forward models generated by the physics simulator and machine learning (constrained by physics-based rules) and optionally validated by the forward proxy model. In turn, the inverse proxy model may be used to generate a set of subsurface inverse models. As discussed above, the inverse models may include inputs directed to any aspect that is able to be sensed and/or entirely controllable, such as parameters related to operations (X_{P}) and the subsurface process data that may be sensed.

After generating one or both of the forward proxy model or inverse proxy model, the model(s) may be used for unconventional hydrocarbon extraction. For example, responsive to receiving subsurface process data, the inverse proxy model may be used to identify a set of potential subsurface models. As discussed above, the identification of the subsurface models may be performed iteratively, such as responsive to receipt of updated subsurface process data, or may be performed once. After which, the identified subsurface models may be analyzed for validation. For example, the identified subsurface inverse models may be validated as discussed below. If validation fails (and the identified subsurface inverse models are not to be used), the identification may be repeated using the forward proxy platform. Regardless, parameters from the identified models (either using the inverse proxy model or the forward proxy model) are analyzed for optimization purposes. For example, geological parameter(s) (X_{G}) and/or parameter(s) related to completions (X_{C}) may be analyzed to determine whether to update parameter(s) related to operations (X_{P}). In this way, a first subsurface may be analyzed to determine one or more aspects of the subsurface, such as geological parameter(s) (X_{G}) and/or parameter(s) related to completions (X_{C}). In turn, production regarding a second subsurface, which may be similar to first subsurface in one or more aspects (e.g., an adjacent field, a field in the same region, etc.) may be optimized accordingly.

Thus, in one or some embodiments, one objective for the methodology may comprise automating subsurface scenario identification for unconventional depletion planning using a hybrid physics/data-driven approach. This is in contrast to current workflows that may not capture all possible subsurface scenarios/uncertainties and may be computationally slower. Further, one technical approach may comprise offline/online stages. In the offline stage, an ‘AI agent’ (such as the proxy model(s)) is built from at least one hundred thousand simulations, at least one million simulations, at least two million simulations that cover potential scenarios, with correlation to field data In the online stage, Geoscientists/Engineers may use the ‘AI agent’ to perform any one, any combination, or all of: understand possible geology/fracture scenarios for a given well(s) performance; inform an initial development/depletion plan for a future pad; and adjust those plans as more field data become available. In this way, the methodology may result in greater value, benefits, or impact including: significant cycle time reduction for depletion planning workflows; and/or enabling quick scoping of the design space/observing trends.

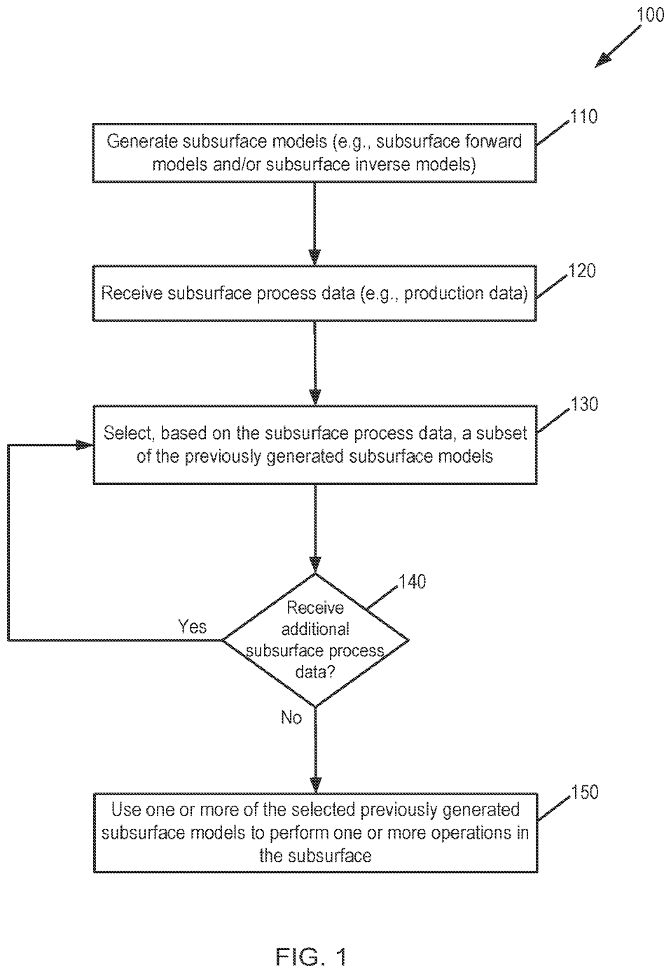

Referring to the figures, FIG. 1 is a flow chart 100 for iteratively selecting or identifying previously generated subsurface models based on subsurface process data. At 110, subsurface models are generated. As discussed above, subsurface forward models (e.g., manifested in the forward proxy model) and/or subsurface inverse models (e.g., manifested in the inverse proxy model) may be generated. At 120, subsurface process data, such as production data or diagnostics data, is received. At 130, a subset of the previously generated subsurface models is selected or identified based on the subsurface process data. For example, the subsurface process data and the parameter(s) related to operations (X_{P}) may be input to the inverse proxy model. In turn, the inverse proxy model may generate a set of potential subsurface models (e.g., output one or both of geological parameter(s) (X_{G}) and/or parameter(s) related to completions (X_{C}) that the inverse proxy model correlates to the subsurface process data and the parameter(s) related to operations (X_{P}) input). In one particular example, production data may include any one, any combination, or all of: production data directed to oil (Yₒᵢₗ); production data directed to gas (Y_{gas}); or production data directed to water (Y_{water}). A specific subsurface inverse model has assigned thereto inputs, including specific production data and specific parameter(s) related to operations (X_{P}). The inverse proxy model, using the production data and specific parameter(s) related to operations (X_{P}), may generate potential combinations of X_{G}/X_{C} indicative of potential subsurface inverse models.

At 140, the methodology determines whether additional subsurface process data has been received. For example, subsurface process data may be sent periodically, such as daily. If so, flow chart 100 loops back to 130 to use the recently received subsurface process data to further refine the selection or identification of potential subsurface models.

If not, flow chart 100 transitions to 150 in which one or more of the selected previously generated subsurface models is used to perform one or more operations in the subsurface. For example, the selected subsurface inverse model(s) may have corresponding outputs, such as outputs indicative of the subsurface and/or indicative of actions in the subsurface. In particular, the outputs may include one or both of geological parameter(s) (X_{G}) and/or parameter(s) related to completions (X_{C}). These outputs may then be used as part of an analysis, such as a cost-benefit analysis, to determine what values to select for controllable parameters in hydrocarbon production in a related subsurface. As one example, a field adjacent to the present field (which generated the production data subject to the present analysis) may be scheduled for hydrocarbon extraction. Depending on the analysis (e.g., optimization as discussed above), the methodology may select one or both of parameter(s) related to operations (X_{P}) and/or parameter(s) related to completions (X_{C}) in order to perform hydrocarbon extraction in the adjacent field. As another example, a field adjacent to the present field (which generated the diagnostics data subject to the present analysis) may be scheduled for stimulation (such as fracking). Depending on the analysis (e.g., optimization as discussed above), the methodology may select one or both of parameter(s) related to operations (X_{P}) and/or parameter(s) related to completions (X_{C}) in order to perform stimulation in the adjacent field. In this regard, the analysis may be used in order to perform one or more operations in the subsurface.

Thus, the methodology may identify the potential subsurface scenarios as reflected, for example, the one or more geological parameter(s) (X_{G}) determined by the methodology, which may be part of depletion planning. Specifically, the methodology may identify one or more aspects of the subsurface (as the one or more geological parameter(s) (X_{G})), and in turn select values for other parameters, such as parameters related to completions (X_{C}) and/or parameters related to operations (X_{P}).

Specifically, an area for exploration may be divided into units, with each unit subject to a development plan (e.g., the number of wells, the amount of water to pump, the number of fractures created, etc.). Particularly in unconventional hydrocarbon extraction, which may be difficult, well performance in an adjacent area (e.g., an adjacent unit) may assist in developing another unit. In this regard, assuming that adjacent units are similar, gaining an understanding of X_{G} and X_{C} in a developed unit may assist in generating a development plan for the adjacent unit.

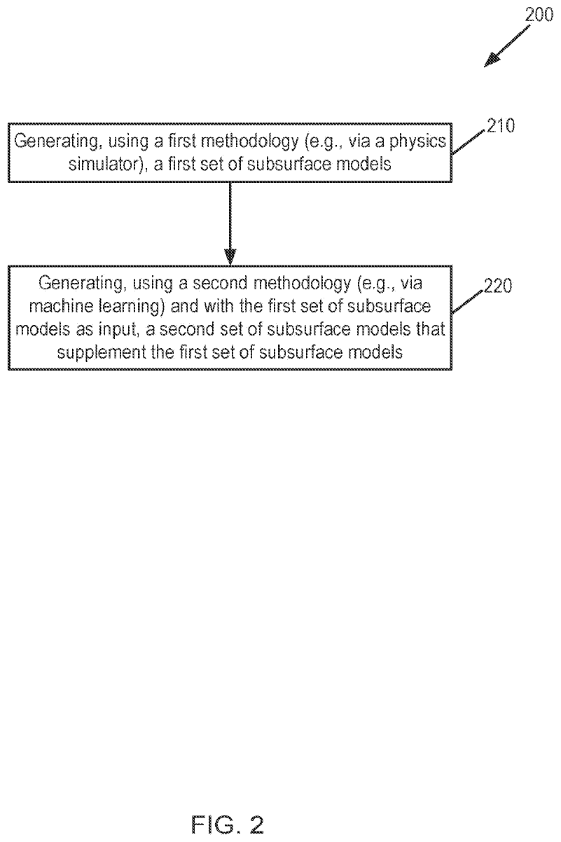

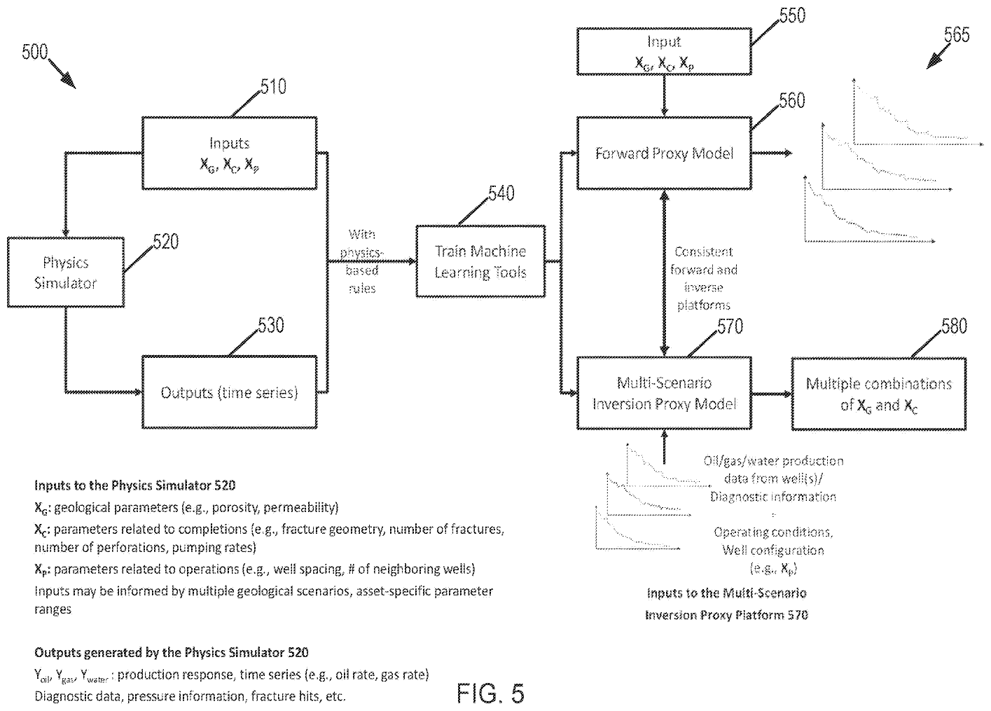

FIG. 2 is a flow chart 200 for generating subsurface models, such as forward subsurface models, using two methodologies. At 210, a first set of subsurface models, such as subsurface forward models, are generated using a first methodology, such as via a physics simulator. At 220, a second set of subsurface models, such as subsurface forward models, are generated using a second methodology, such as by generating a proxy model (such as a forward proxy model and/or an inverse proxy model) via machine learning. The proxy model may thus manifest the subsurface models. In one or some embodiments, part or all of the first set of models are used as input, such as for training the machine learning algorithm, as discussed with regard to FIG. 5.

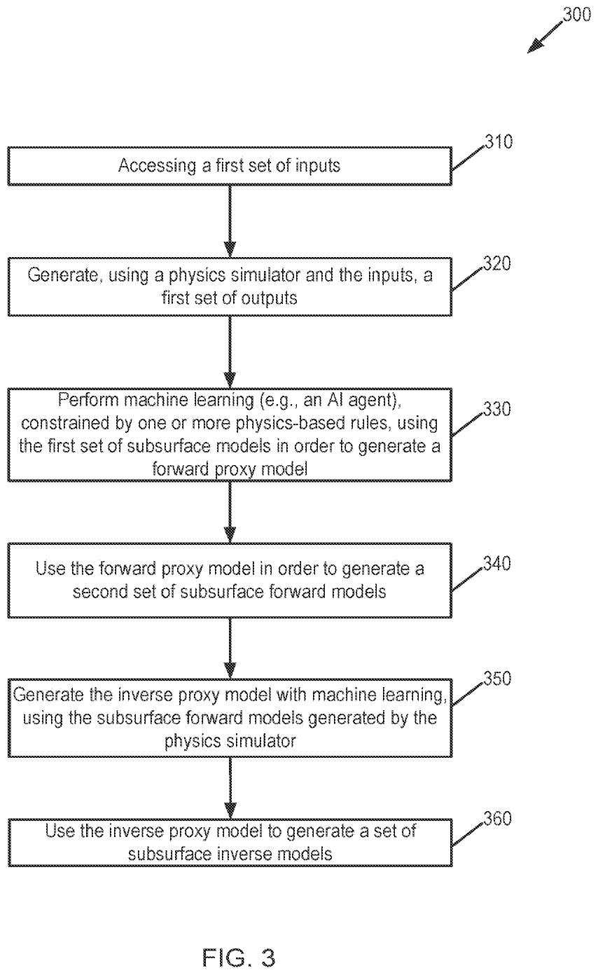

FIG. 3 is a flow chart 300 for using a physics simulator to generate forward models, machine learning to generate a forward proxy model (using the forward models), machine learning to generate the inverse proxy model (using the forward models and optionally validating the inverse proxy model using the forward proxy model, and for using the inverse proxy model to generate a set of inverse subsurface models. At 310, a first set of inputs are accessed. For example, the first set of inputs may include different production inputs, such as different sets of values for geological parameters (X_{G}), parameters related to completions (X_{C}), and parameters related to operations (X_{P}). At 320, a first set of outputs are generated using a physics simulator. For example, the first set of outputs may comprise production outputs, which may be represented as a time series for one, some, or each of production data directed to oil (Yₒᵢₗ), production data directed to gas (Y_{gas}), and production data directed to water (Y_{water}). In this regard, a subsurface forward model may be created by pairing a respective set of inputs (which were input to the physics simulator) with the respective set of outputs (which were generated by the physics simulator for the respective set of inputs), so that a first set of subsurface forward models may be created for the different sets of inputs. As discussed above, the physics simulator may generate the respective set of outputs for a respective set of inputs in a matter of minutes. Further, the physics simulator may be tasked with creating outputs responsive to 100 thousand different inputs, thereby creating 100 thousand forward models as the first set of subsurface forward models for subsequent use.

At 330, machine learning is performed, such as by using an AI agent, using the first set of subsurface models in order to generate a forward proxy model. In one or some embodiments, the machine learning may be constrained in one or more aspects, such as constrained by one or more physics-based rules in order to converge on the forward proxy model. The physics-based rules may be manifested in the machine learning in one of several ways in order to constrain the machine learning. Merely by example, one physics-based rule may correlate one parameter with another. In particular, one example rule may correlate permeability (one parameter) with oil rates (another parameter) in which responsive to a value for permeability being higher, the value for oil rates would likewise be higher. Another example rule may correlate well spacing with production in which closer well spacing is correlated to lower production. In this regard, the physics-based rules may correlate one or more parameters(s) of the machine learning with one or more other parameters of the machine learning thereby assisting in generating the proxy model (such as assisting in the convergence to the proxy model). Merely by way of example, the parameters correlated to one another may be for use in generating the forward proxy model: both inputs; to only inputs and outputs; or to only outputs. Likewise, the parameters correlated to one another may be for use in generating the inverse proxy model: both inputs; to only inputs and outputs; or to only outputs. In addition, in one or some embodiments, the physics-based rules used for the machine learning are the same in generating both the forward proxy model and the inverse proxy model. Moreover, the correlation between parameters may be a linear, an exponential, or a logarithmic relationship to honor the natural constraints of the physics-based rules. The rules may be encoded such that the rules are honored in the process of the machine learning. Encoding these physics-based rules, which comport with physically reasonable outcomes, leads to a considerable improvement in generating the forward proxy model (either in terms of accelerating convergence on the forward proxy model or enabling convergence at all).

At 340, the forward proxy model may be used in order to generate a second set of subsurface forward models. As discussed above, the forward proxy model may have manifested therein subsurface forward models with inputs that are interpolated from the inputs used as input to the physics simulator. Further, as discussed above, the computational cost in using the physics simulator to generate a subsurface forward model is higher than in using the forward proxy model. In that regard, when receiving subsurface process data, the forward proxy model may be used much more quickly to generate subsurface forward models than the physics simulator.

At 350, machine learning, using the subsurface forward models generated by the physics simulator, may generate the inverse proxy model (and optionally validated by the forward proxy model for consistency) is used to generate the inverse proxy model. At 360, the inverse proxy model is used in order to generate a set of inverse subsurface inverse models. As discussed above, responsive to receiving subsurface process data, the inverse proxy model may be used to identify potential combinations of X_{G}/X_{C}.

FIG. 4 is a flow chart 400 for iteratively selecting or identifying inverse subsurface models based on subsurface process data and determining whether to use the selected inverse subsurface models. At 410, subsurface process data and parameters related to operations (X_{P}) are accessed. At 420, using the inverse proxy model and the accessed subsurface process data and X_{P}, multiple combinations of X_{G} and X_{C} are generated. For example, responsive to receiving updated subsurface process data at predetermined times, the potential combinations of X_{G} and X_{C} are iteratively updated based on updated subsurface process data. After a predetermined number of iterations or after the potential combinations of X_{G} and X_{C} remain constant after multiple iterations, flow chart 400 proceeds to 430 where the final set of combinations for X_{G} and X_{C} are validated. Validation, on a basic level, is a reflection of the confidence in the inverse proxy model. Validation may take one or more forms, including without limitation: (i) feeding the outputs from the inverse model (e.g., X_{G} and/or X_{C}) into the subsurface forward models to determine if the output(s) from the forward model match (within tolerance) of the inputs to the subsurface inverse model; and/or (ii) feeding the outputs from the inverse model into the physics simulator to determine if the output(s) from the physics simulator match (within tolerance) of the inputs to the subsurface inverse model.

At 440, it is determined whether the final set of combinations for X_{G} and X_{C} are valid. If yes, at 470, the final set of combinations of X_{G} and X_{C} are analyzed to determine one or more combinations of X_{G} and X_{C} for further analysis. At 480, the one or more combinations of X_{G} and X_{C} are then analyzed to determine whether to update the X_{P} for subsequent subsurface operations (e.g., whether to modify parameters for production and/or for stimulation). Alternatively, or in addition, one or more parameters associated with related to completions (X_{C}) that are controllable may be modified or updated. After which, at 490, the updated X_{P} is used in the subsequent subsurface operations. For example, one or more parameters related to operations (X_{P}) may be updated or selected based on the analysis. Alternatively, or in addition, one or more parameters related to completions (X_{C}) that are controllable may be updated or selected based on the analysis. As discussed above, the updated or selected parameters may then be used in one or more subsurface operations, including hydrocarbon extraction, stimulation, or the like.

If the final set of combinations for X_{G} and X_{C} are invalid, the forward models may be used. For example, at 450, different potential combinations of X_{G} and X_{C} are generated. At 460, from the different potential combinations of X_{G} and X_{C}, a final set of combinations of X_{G} and X_{C} are identified by analyzing the forward subsurface models, the accessed subsurface process data and X_{P}. After which, flow chart 400 may move to 470 in order to analyze the final set of combinations of X_{G} and X_{C}.

FIG. 5 is a block diagram 500 for generating and using the subsurface models. Inputs X_{G}, X_{C} and X_{P} (510) are input to physics simulator 520 in order to generate Outputs (530), which may be in the form of a time series. As discussed above, various outputs are contemplated. As one example, the outputs may comprise production data and include Yₒᵢₗ, Y_{gas}, Y_{water}. As another example, the outputs may include diagnostic data and comprise pressure information, fracture hits, etc. In this way, physics simulator 520 may generate a first set of subsurface forward models, pairing respective Inputs X_{G}, X_{C} and X_{P} (510) with respective Outputs (530). The first set of subsurface forward models (acting as a training set of subsurface forward models) may then be used along with physics-based rules by Machine Learning Tools 540 for training in order to generate Forward Proxy Model 560. Various machine learning tools are contemplated, including histogram gradient, adaptive boosting on decision trees, random forest, or deep learning models (e.g., deep neural networks, deep belief networks, graph neural networks, recurrent neural networks, and convolutional neural networks).

After training of Forward Proxy Model 560, another set of Inputs X_{G}, X_{C} and X_{P}(550) are input to Forward Proxy Model 560 in order to generate Outputs 565 (shown as time series outputs which may include Yₒᵢₗ, Y_{gas}, Y_{water}). In this way, Forward Proxy Model 560, which manifests subsurface forward models with inputs that are interpolated to Inputs X_{G}, X_{C} and X_{P} (510), may receive as Inputs X_{G}, X_{C} and X_{P} (550) in order to generate Outputs 565 for the second set of subsurface forward models. Again, Outputs 565 are merely one example of the outputs contemplated.

In turn, the first set of subsurface forward models may be used along with physics-based rules by Machine Learning Tools 540 for training in order to generate Multi-Scenario Inversion Proxy Model 570 (with validation by Forward Proxy Model 560 so that Forward Proxy Model 560 and Multi-Scenario Inversion Proxy Model 570 are consistent with one another). After generating Multi-Scenario Inversion Proxy Model 570, Multi-Scenario Inversion Proxy Model 570 may be used to generate a plurality of subsurface inversion models (e.g., pairing Yₒᵢₗ, Y_{gas}, Y_{water} and X_{P} as inputs and potential X_{G}, X_{C} as outputs; pairing diagnostic information and X_{P} as inputs and potential X_{G}, X_{C} as outputs).

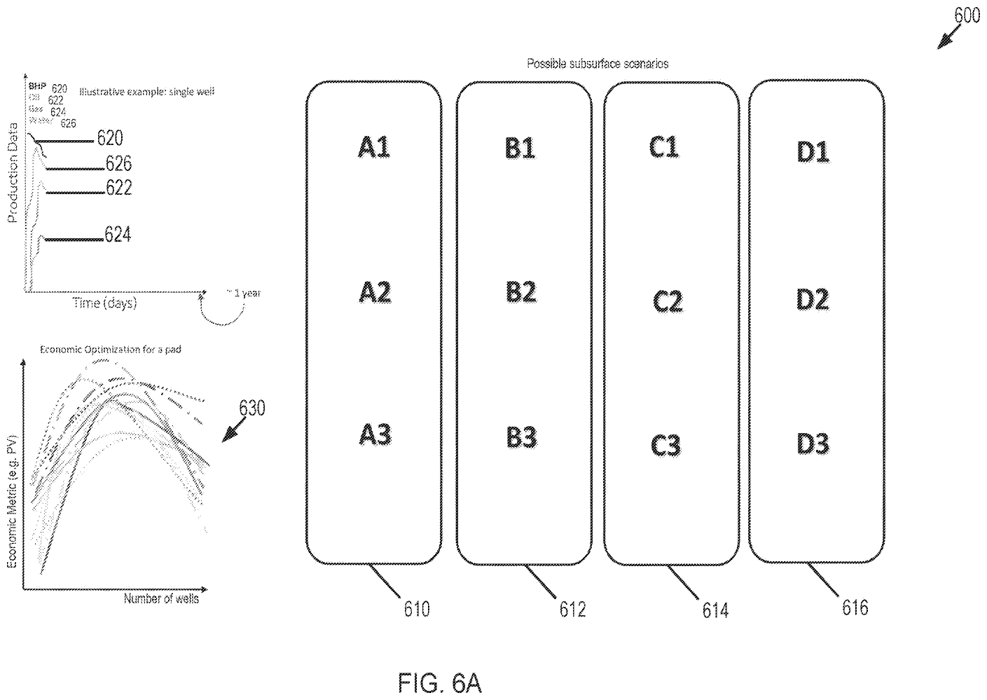

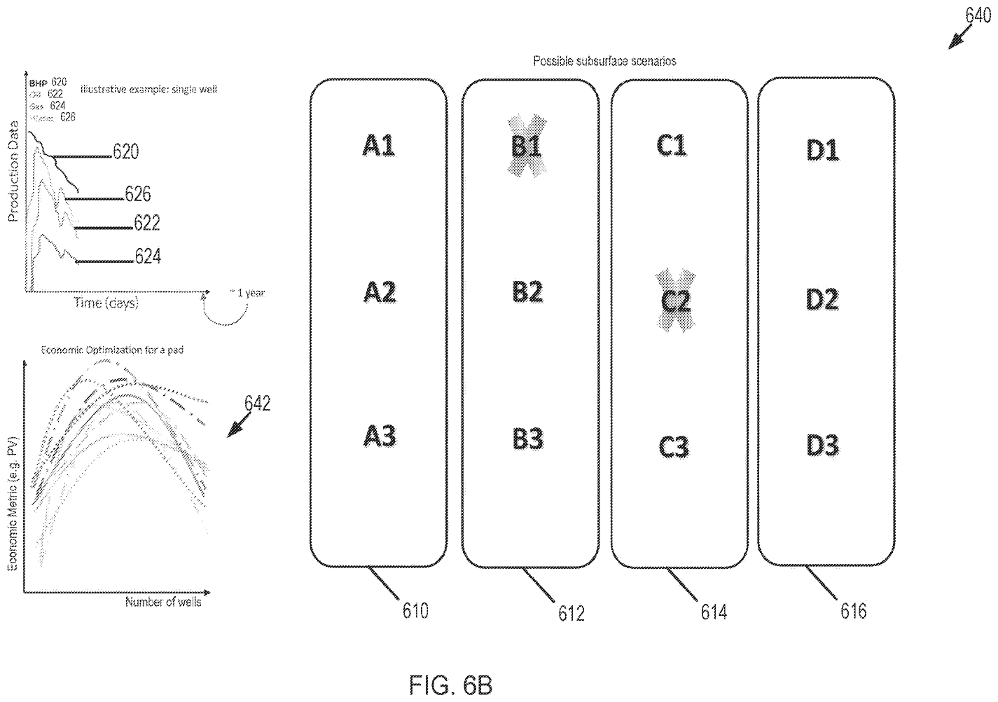

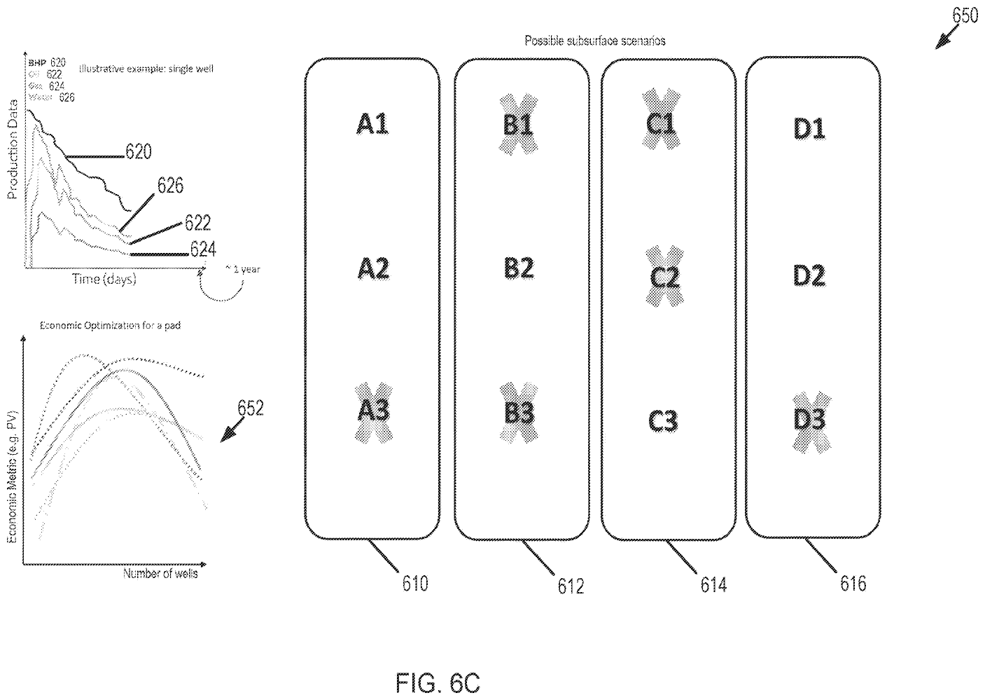

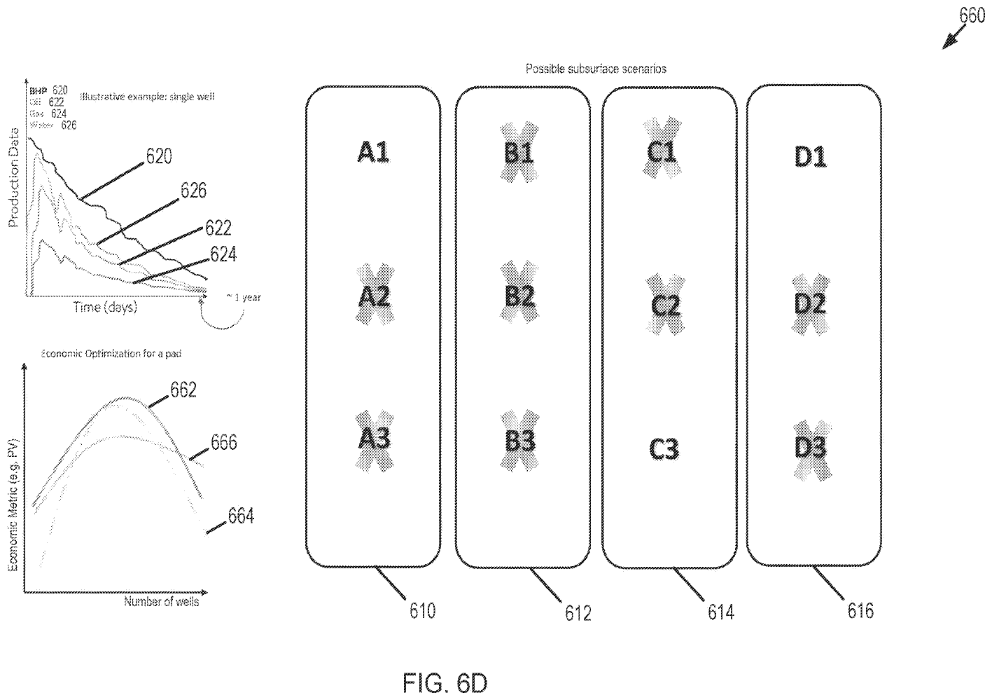

As an example, when production data Yₒᵢₗ, Y_{gas}, Y_{water} is received from the field, production data Yₒᵢₗ, Y_{gas}, Y_{water} and X_{P} may be paired as inputs to Multi-Scenario Inversion Proxy Model 570 in order to generate multiple combinations of X_{G}, X_{C} (580) as potential candidates, as discussed further with regard to FIG. 6A-D. Alternatively, or in addition, diagnostic data may be used from adjacent fields.

In this way, block diagram 500 is one way in which to meet one or more goals, including: creating a fully parameterized dataset that covers multiple scenarios (e.g., parameter ranges anchored to field observations); and/or creating a reliable, robust proxy model capable of interpolating in the high dimensional dataset. As discussed above, a full-physics simulator (such as physics simulator 520) may be used to run many simulations in parallel (e.g., such as at least 30 dimensions, at least 40 dimensions, at least 50 dimensions, at least 60 dimensions, etc.). Further, machine learning, such as deep learning models constrained by physics-based rules, may use the evaluation dataset.

FIGS. 6A-D are block diagrams 600, 640, 650, 660 for iteratively reducing the potential inverse subsurface models based on the production data received. As discussed above, various subsurface process data, including production data or diagnostics data, may be observed. FIGS. 6A-D uses production data merely by way of example. In this regard, diagnostics data may likewise be used to iteratively reduce the potential inverse subsurface models.

In particular, FIG. 6A illustrates production data received for a single well for a first time period (e.g., t=1), including curves of production data versus time for bottom hole pressure (BHP) 620, oil 622, gas 624, and water 626. Given the production data from the first time period and the X_{P}, the inverse proxy model may be used to identify the subset of potential subsurface inverse models that match (within tolerance) the production data from the first time period and the X_{P} (e.g., the possible subsurface scenarios) As shown, 12 models match, with grouping identified in 4 general categories including category A 610, category B 612, category C 614, and category D 616. Various categories are contemplated. Further, fewer or greater than 4 categories are contemplated. Also, each of the 12 models have corresponding curves 630 of number of wells versus one or more economic metrics (e.g., present value (PV)) that are indicative of economic optimization for a pad.

FIG. 6B illustrates production data received for the single well through a second time period (e.g., t=2). As shown, due to the additional production data, certain potential subsurface scenarios, such as B1 and C2, may be eliminated, resulting in fewer curves 642.

FIG. 6C illustrates production data received for the single well through a third time period (e.g., t=3). As shown, due to even more production data, certain potential subsurface scenarios, such as A3, B3, C1, and D3, may be eliminated, resulting in even fewer curves 652.

FIG. 6D illustrates production data received for the single well through a fourth time period (e.g., t=4). As shown, due to even more production data, certain potential subsurface scenarios, all but A1, C3 and D1, may be eliminated, resulting in three curves with curve 662 associated with A1, curve 664 associated with C3, and curve 666 associated with D1.

Thus, the analysis represented in FIGS. 6A-D identifies three potential scenarios. In one or some embodiments, additional information may be present to exclude one or two of the remaining three potential scenarios. Alternatively, additional information may be unavailable. In this regard, the analysis may consider one, some, or each of the three potential scenarios in determining one or more parameters associated with X_{G} and/or X_{C}. As shown in FIGS. 6A-D, the optimum number of wells is considered based on the curves 662, 664, 666 associated with the three potential scenarios.

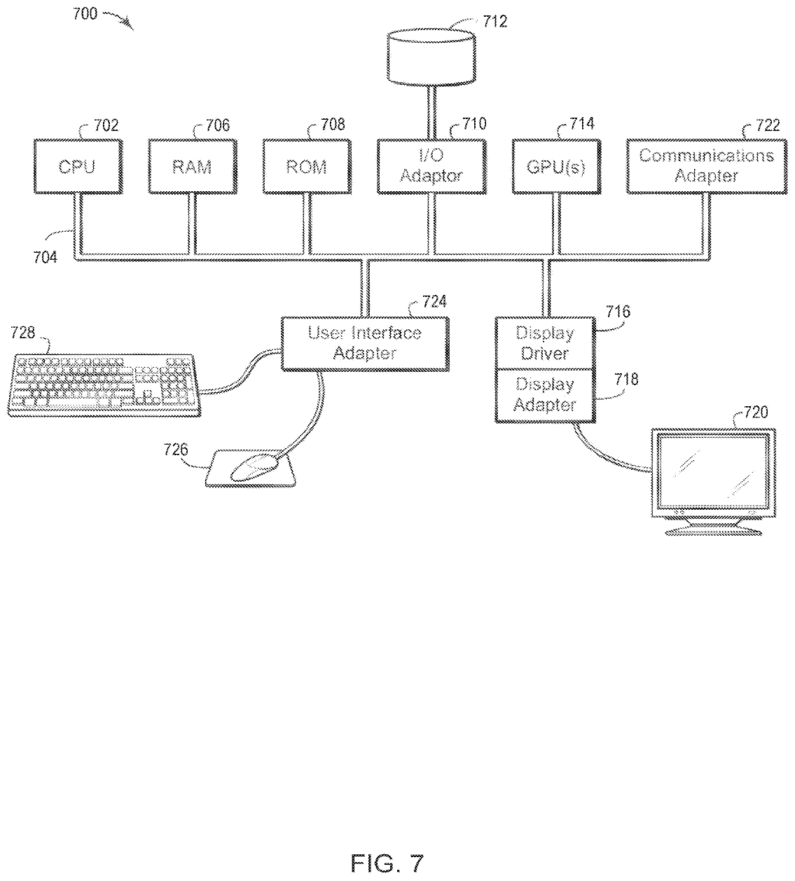

In all practical applications, the present technological advancement must be used in conjunction with a computer, programmed in accordance with the disclosures herein. For example, FIG. 7 is a diagram of an exemplary computer system 700 that may be utilized to implement methods described herein. A central processing unit (CPU) 702 is coupled to system bus 704. The CPU 702 may be any general-purpose CPU, although other types of architectures of CPU 702 (or other components of exemplary computer system 700) may be used as long as CPU 702 (and other components of computer system 700) supports the operations as described herein. Those of ordinary skill in the art will appreciate that, while only a single CPU 702 is shown in FIG. 7, additional CPUs may be present. Moreover, the computer system 700 may comprise a networked, multi-processor computer system that may include a hybrid parallel CPU/GPU system. The CPU 702 may execute the various logical instructions according to various teachings disclosed herein. For example, the CPU 702 may execute machine-level instructions for performing processing according to the operational flow described.

The computer system 700 may also include computer components such as non-transitory, computer-readable media. Examples of computer-readable media include computer-readable non-transitory storage media, such as a random access memory (RAM) 706, which may be SRAM, DRAM, SDRAM, or the like. The computer system 700 may also include additional non-transitory, computer-readable storage media such as a read-only memory (ROM) 708, which may be PROM, EPROM, EEPROM, or the like. RAM 706 and ROM 708 hold user and system data and programs, as is known in the art. The computer system 700 may also include an input/output (I/O) adapter 710, a graphics processing unit (GPU) 714, a communications adapter 722, a user interface adapter 724, a display driver 716, and a display adapter 718.

The I/O adapter 710 may connect additional non-transitory, computer-readable media such as storage device(s) 712, including, for example, a hard drive, a compact disc (CD) drive, a floppy disk drive, a tape drive, and the like to computer system 700. The storage device(s) may be used when RAM 706 is insufficient for the memory requirements associated with storing data for operations of the present techniques. The data storage of the computer system 700 may be used for storing information and/or other data used or generated as disclosed herein. For example, storage device(s) 712 may be used to store configuration information or additional plug-ins in accordance with the present techniques. Further, user interface adapter 724 couples user input devices, such as a keyboard 728, a pointing device 726 and/or output devices to the computer system 700. The display adapter 718 is driven by the CPU 702 to control the display on a display device 720 to, for example, present information to the user such as subsurface images generated according to methods described herein.

The architecture of computer system 700 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 700 may include various plug-ins and library files. Input data may additionally include configuration information.

Preferably, the computer is a high-performance computer (HPC), known to those skilled in the art. Such high-performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft, Amazon.

The above-described techniques, and/or systems implementing such techniques, can further include hydrocarbon management based at least in part upon the above techniques, including using the one or more generated geological models in one or more aspects of hydrocarbon management. For instance, methods according to various embodiments may include managing hydrocarbons based at least in part upon the one or more generated geological models and data representations (e.g., seismic images, feature probability maps, feature objects, etc.) constructed according to the above-described methods. In particular, such methods may include drilling a well, and/or causing a well to be drilled, based at least in part upon the one or more generated geological models and data representations discussed herein (e.g., such that the well is located based at least in part upon a location determined from the models and/or data representations, which location may optionally be informed by other inputs, data, and/or analyses, as well) and further prospecting for and/or producing hydrocarbons using the well.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some or all of the steps in the disclosed method are performed using a computer so that the methodology is computer implemented. In such cases, the resulting physical properties model may be downloaded or saved to computer storage.

The following example embodiments of the invention are also disclosed.

Embodiment 1: A computer-implemented method for analyzing subsurface process data in order to perform one or more subsurface operations in a subsurface, the method comprising:
accessing the subsurface process data indicative of at least one subsurface process, the subsurface process data being periodically generated;
analyzing, using the subsurface process data, previously generated subsurface models in order to select a subset of previously generated subsurface models;
iteratively, responsive to receiving additional subsurface process data, analyzing, using the additional subsurface process data, reducing the previously generated subsurface models in the subset; and
using one or more of the previously generated subsurface models in the subset in order to perform the one or more subsurface operations in the subsurface.

Embodiment 2: The method of embodiment 1:
wherein the previously generated subsurface models are manifested in a proxy model; and
wherein the proxy model is configured to receive the subsurface process data and the additional subsurface process data and to generate outputs indicative of the previously generated subsurface models.

Embodiment 3: The method of embodiments 1 or 2:
wherein the proxy model is generated by:
   generating a training set of subsurface models; and
   generating the proxy model using the training set of subsurface models.

Embodiment 4: The method of embodiments 1-3:
wherein the training set of subsurface models are generated via a non-machine learning methodology; and
wherein the proxy model is generated via machine learning using the training set of subsurface models.

Embodiment 5: The method of embodiments 1-4:
wherein the non-machine learning methodology comprises solving differential equations.

Embodiment 6: The method of embodiments 1-5:
wherein a forward proxy model is generated via the machine learning using the training set of subsurface models;
wherein, after generating the forward proxy model, an inverse proxy model is generated via the machine learning using the training set of subsurface models and to be consistent with the forward proxy model; and
wherein the inverse proxy model is configured to receive the subsurface process data and the additional subsurface process data and to generate outputs comprising geological parameters and parameters related to completions.

Embodiment 7: The method of embodiments 1-6:
wherein the machine learning to generate the forward proxy model is constrained by physics-based rules; and
wherein the machine learning to generate the inverse proxy model is constrained by the physics-based rules.

Embodiment 8: The method of embodiments 1-7:
wherein a physics simulator, solving differential equations, generates a training set of subsurface forward models;
wherein the machine learning, constrained by the physics-based rules, generates the forward proxy model using the training set of subsurface forward models; and
wherein the machine learning, constrained by the physics-based rules, generates the inverse proxy model using the training set of subsurface forward models.

Embodiment 9: The method of embodiments 1-8:
wherein the forward proxy model receives input parameters and generates output parameters; and
wherein the physics-based rules correlate one or more input parameters to one or more output parameters.

Embodiment 10: The method of embodiments 1-9:
wherein the correlation of the physics-based rules is any one of linear, logarithmic, or exponential.

Embodiment 11: The method of embodiments 1-10:
wherein the machine learning comprises a deep learning model.

Embodiment 12: The method of embodiments 1-11:
wherein the subsurface process data comprises production data; and
wherein the inverse proxy model inputs the production data and outputs the geological parameters and the parameters related to completions that are indicative of potential inverse models.

Embodiment 13: The method of embodiments 1-12:
wherein the subsurface process data comprises diagnostics data; and
wherein the inverse proxy model inputs the diagnostics data and outputs the geological parameters and the parameters related to completions that are indicative of potential inverse models.

Embodiment 14: A system comprising:
a processor; and
a non-transitory machine-readable medium comprising instructions that, when executed by the processor, cause a computing system to perform a method according to any of embodiments 1-13.

Embodiment 15: A non-transitory machine-readable medium comprising instructions that, when executed by a processor, cause a computing system to perform a method according to any of embodiments 1-13.

Embodiment 16: A computer-implemented method for generating an inverse proxy model in order to perform one or more subsurface operations in a subsurface, the method comprising:
generating, using a physics simulator solving differential equations, a training set of forward models;
generating, via machine learning using the training set of forward models, a forward proxy model;
generating, via the machine learning using the training set of forward models, an inverse proxy model such that the inverse proxy model is consistent with the forward proxy model;
receiving subsurface process data;
using the subsurface process data as input to the inverse proxy model in order to generate outputs comprising geological parameters and parameters related to completions that are indicative of potential inverse models; and
using one or more of the potential inverse models to perform the one or more subsurface operations in the subsurface.

Embodiment 17: The method of embodiment 16:
wherein the machine learning to generate the forward proxy model is constrained by physics-based rules; and
wherein the machine learning to generate the inverse proxy model is constrained by the physics-based rules.

Embodiment 18: The method of embodiments 16 or 17:
wherein the forward proxy model receives input parameters and generates output parameters; and
wherein the physics-based rules correlate one or more input parameters to one or more output parameters.

Embodiment 19: The method of embodiments 16-18:
wherein the correlation of the physics-based rules is any one of linear, logarithmic, or exponential.

Embodiment 20: The method of embodiments 16-19: wherein the machine learning comprises a deep learning model.

Embodiment 21: The method of embodiments 16-20:
further comprising generating, using the forward proxy model, a number of forward models;
wherein the number of forward models generated by the forward proxy model is at least one order of magnitude greater than a number of the training set of forward models generated by the physics simulator and used for machine learning to generate the forward proxy model; and
wherein a computational time for the forward proxy model to generate one of the forward models is at least an order of magnitude less than the computational time for the physics simulator to generate one forward model in the training set of forward models.

Embodiment 22: The method of embodiments 16-21:
further comprising:
   validating, using the forward proxy model, the potential inverse models; and
   responsive to determining that the potential inverse models are invalid, using the proxy model in order to determine the geological parameters and the parameters related to completions.

Embodiment 23: A system comprising:
a processor; and
a non-transitory machine-readable medium comprising instructions that, when executed by the processor, cause a computing system to perform a method according to any of embodiments 16-22.

Embodiment 24: A non-transitory machine-readable medium comprising instructions that, when executed by a processor, cause a computing system to perform a method according to any of embodiments 16-22.

What is claimed is:

1. A computer-implemented method for analyzing subsurface process data in order to perform one or more subsurface operations in a subsurface, the method comprising:
accessing the subsurface process data indicative of at least one subsurface process, the subsurface process data being periodically generated;
analyzing, using the subsurface process data, previously generated subsurface models in order to select a subset of previously generated subsurface models;
iteratively, responsive to receiving additional subsurface process data, analyzing, using the additional subsurface process data, reducing the previously generated subsurface models in the subset; and
using one or more of the previously generated subsurface models in the subset in order to perform the one or more subsurface operations in the subsurface.

2. The method of claim 1, wherein the previously generated subsurface models are manifested in a proxy model; and
wherein the proxy model is configured to receive the subsurface process data and the additional subsurface process data and to generate outputs indicative of the previously generated subsurface models.

3. The method of claim 2, wherein the proxy model is generated by:
generating a training set of subsurface models; and
generating the proxy model using the training set of subsurface models.

4. The method of claim 3, wherein the training set of subsurface models are generated via a non-machine learning methodology; and
wherein the proxy model is generated via machine learning using the training set of subsurface models.

5. The method of claim 4, wherein the non-machine learning methodology comprises solving differential equations.

6. The method of claim 4, wherein a forward proxy model is generated via the machine learning using the training set of subsurface models;
wherein, after generating the forward proxy model, an inverse proxy model is generated via the machine learning using the training set of subsurface models and to be consistent with the forward proxy model; and
wherein the inverse proxy model is configured to receive the subsurface process data and the additional subsurface process data and to generate outputs comprising geological parameters and parameters related to completions.

7. The method of claim 6, wherein the machine learning to generate the forward proxy model is constrained by physics-based rules; and
wherein the machine learning to generate the inverse proxy model is constrained by the physics-based rules.

8. The method of claim 7, wherein a physics simulator, solving differential equations, generates a training set of subsurface forward models;
wherein the machine learning, constrained by the physics-based rules, generates the forward proxy model using the training set of subsurface forward models; and
wherein the machine learning, constrained by the physics-based rules, generates the inverse proxy model using the training set of subsurface forward models.

9. The method of claim 8, wherein the forward proxy model receives input parameters and generates output parameters; and
wherein the physics-based rules correlate one or more input parameters to one or more output parameters.

10. The method of claim 9, wherein the correlation of the physics-based rules is any one of linear, logarithmic, or exponential.

11. The method of claim 9, wherein the machine learning comprises a deep learning model.

12. The method of claim 8, wherein the subsurface process data comprises production data; and
wherein the inverse proxy model inputs the production data and outputs the geological parameters and the parameters related to completions that are indicative of potential inverse models.

13. The method of claim 8, wherein the subsurface process data comprises diagnostics data; and
wherein the inverse proxy model inputs the diagnostics data and outputs the geological parameters and the parameters related to completions that are indicative of potential inverse models.

14. A computer-implemented method for generating an inverse proxy model in order to perform one or more subsurface operations in a subsurface, the method comprising:
generating, using a physics simulator solving differential equations, a training set of forward models;
generating, via machine learning using the training set of forward models, a forward proxy model;
generating, via the machine learning using the training set of forward models, an inverse proxy model such that the inverse proxy model is consistent with the forward proxy model;
receiving subsurface process data;
using the subsurface process data as input to the inverse proxy model in order to generate outputs comprising geological parameters and parameters related to completions that are indicative of potential inverse models; and
using one or more of the potential inverse models to perform the one or more subsurface operations in the subsurface.

15. The method of claim 14, wherein the machine learning to generate the forward proxy model is constrained by physics-based rules; and
wherein the machine learning to generate the inverse proxy model is constrained by the physics-based rules.

16. The method of claim 15, wherein the forward proxy model receives input parameters and generates output parameters; and
wherein the physics-based rules correlate one or more input parameters to one or more output parameters.

17. The method of claim 16, wherein the correlation of the physics-based rules is any one of linear, logarithmic, or exponential.

18. The method of claim 16, wherein the machine learning comprises a deep learning model.

19. The method of claim 14, further comprising generating, using the forward proxy model, a number of forward models;
wherein the number of forward models generated by the forward proxy model is at least one order of magnitude greater than a number of the training set of forward models generated by the physics simulator and used for machine learning to generate the forward proxy model; and
wherein a computational time for the forward proxy model to generate one of the forward models is at least an order of magnitude less than the computational time for the physics simulator to generate one forward model in the training set of forward models.

20. The method of claim 14, further comprising:
validating, using the forward proxy model, the potential inverse models; and
responsive to determining that the potential inverse models are invalid, using the proxy model in order to determine the geological parameters and the parameters related to completions.
